(19) United States
(12) Patent Application Publication
(10) Pub. No.: US 2017/0209789 A1
(43) Pub. Date: Jul. 27, 2017

(54) Laser Game System

(71) Applicant: Proxy42, Inc., San Francisco, CA (US)

(72) Inventors: Francesco Ferrazzino, Lucca (IT); Zulay Giglioia Barrero Calixto, Trento (CO); Annalisa Dalbon, Dare (IT); Jerome Boye, Paris (FR)

(21) Appl. No.: 15/003,587

(22) Filed: Jan. 21, 2016

(51) Int. Cl. A63F 13/335; A63F 13/235; A63F 13/32; A63F 13/837; A63F 13/213

(52) U.S. Cl. CPC A63F 13/335; A63F 13/837; A63F 13/213; A63F 13/32; A63F 13/235

(57) ABSTRACT

The present invention provides a virtual shooting game system, comprising a plurality of player units, each player unit comprising:
a directional radiation source capable of selectively generating a radiation representative of a virtual shot,
at least one radiation sensor for detecting radiation emitted by other units,
a camera,
a display with an aiming sight,
a direction-indicating sensor,
a satellite-based unit positioning means,
communications channels between units,
location means for determining the position of each unit, using position information delivered by said positioning means and, whenever said position information is not available or reliable at a given unit, shot direction information provided by the direction indicating sensor of at least one unit.

### FIELD OF THE INVENTION

The present invention relates to “Laser game” type gaming systems.

### BACKGROUND OF THE INVENTION

A so-called “Laser game” consists in forming two teams of players, each player being equipped with a Laser gun on the one hand, and with a Laser-sensitive vest on the other hand. The gun is connected to the vest and includes electronic circuitry that records the number of shoots delivered to other players and received. The guns are also connected to a personal computer (PC) via a Wi-Fi connection.

The PC executes a program that manages the game and in particular that defines the shoot reserve of each player at the beginning of the game, the game duration and the score of each player, computed from the number of successful shots, the number of received shots, the cumulative shot numbers by team, tournament data, etc. Alternatively and to avoid the need for players to wear a vest, certain known guns are provided themselves with Laser radiation sensors.

More recently it has been conceived to combine a Laser game gun with a smartphone running an augmented reality program. For instance, the “AppTag Laser Blaster®” and “Hasbro Lazer Tag Augmented Reality®” devices are guns provided with a special dock for insertion and securement of a smartphone. The smartphone is thus secured to the gun to form a unit used by player for aiming and shooting.

In some commercial systems, the program displays as a superimposition onto the real image game-related information such as weapons, ammunition, armors, emergency equipment, remaining game duration, score; a representation of the weapon at the foreground, a fixed target at the center of the smartphone screen; a representation of a shot from the weapon barrel toward the target. A player can thus aim at the weapon of his opponent by using the center sight.

In such known systems, each weapon is provided with a so-called “Laser” or “Lazer”, that is actually a front infrared source provided with a collimator and a lens for generating a long range radiation, with a set of omnidirectional infrared sources, and with infrared sensors or cells, also omnidirectional. When a player shoots towards the opponent's weapon barrel, an infrared (IR) radiation is emitted by his/her weapon and is sensed by the target weapon, which in turn emits an omnidirectional IR signal sensed by the shooter's weapon. A virtual burst is then shown on the shooter's smartphone screen, as a superimposition on the real target weapon.

These known systems have a first limitation: with collimation, the ray must be directed precisely; without collimation, the range of an infrared signal is very limited in the free air environment (typically less that 10 meters), as the signal has to be emitted in a spherical pattern and the loss of signal power decreases rapidly with distance (being noted that increasing the source power is incompatible with other technical constraints). This limitation constraints the information exchange between devices or units.

Therefore, these known systems provide a relatively limited gaming experience.

Thus it could be desirable to mix augmented reality and team management, to position in the game real environment virtual objects such as flags, clues, weapons, medical of food resources, to provide to the players a map of this environment together with virtual territory information, to determine the position of each player on the map, to allocate to the players properties such as nicknames, powers, scores, avatars, wounds or moods, to provide for virtual interactions with real objects in addition to enemy weapons, to apply virtual textures to the real environment.

It has further been observed that the constraints including the distance between devices, the battery life, interferences caused by obstacles and other electronic devices not belonging to the system, the need for fast processing by the smartphone program for achieving a realistic rendering and the technical capabilities of smartphone make it difficult to significantly improve such know games. For instance, increasing the frequency and amount of information exchanged between smartphone would unavoidably decrease their battery life. More generally, each attempt to improve a system feature will be detrimental to the performance of another feature.

### SUMMARY OF THE INVENTION

The present invention seeks to provide a system and method ensuring an effective and accurate geographical location of players despite numerous constraints including distance between devices, battery lifetime of devices, interferences caused by obstacles and by other electronic devices which do not participate to the game, by inherent GPS inaccuracies and by other technical limitations, in order to achieve an improved gaming experience.

According to a first aspect, the present invention provides a virtual shooting game system, comprising a plurality of player units, each player unit comprising:

a directional radiation source capable of selectively generating a radiation representative of a virtual shoot

at least one radiation sensor for detecting radiation emitted by other units,

a camera,

a display with an aiming sight,

a direction-indicating sensor,

a satellite-based unit positioning means,

communications channels between units,

location means for determining the position of each unit, using position information delivered by said positioning means and, whenever said position information is not available or reliable at a given unit, shot direction information provided by the direction indicating sensor of at least one unit.

Preferred but non limiting aspects of this system include the following features, taken individually or in any technically compatible combinations:
said shot direction information is determined at the time a virtual shot is generated at said given unit and received at another unit, or vice versa.
said location means further use position uncertainty information based on the maximum displacement velocity of a player holding a unit combined with time difference information between a previous time at which a position had been determined or estimated and a current time.
each unit further comprises distance determination means, and said location means further use inter-unit distance information provided by said distance determination means.
each unit comprises a plurality of radiation sensors receptive to radiation reaching the unit from different directions, respectively, and said location means further use geometric information corresponding to reception patterns of said plurality of radiation sensors.
said location means comprises reference point identification means for identifying in the images captured by the camera reference points having visual identity and known position.
said location means further use an uncertainty factor of the position information delivered by said positioning means.
said location means use a plurality of shot directions provided by the direction indicating sensors of at least two units generating shots in a cross-shooting situation.
each unit comprises a combination of a dedicated unit and a standard smart communicating terminal, the dedicated including the directional radiation source an the radiation sensors.
each unit further comprises a wireless communications channel between the smart terminal and the dedicated unit.

According to a second aspect, the present invention provides a virtual shooting game system, comprising a plurality of player units, each player unit comprising:

a directional radiation source capable of selectively generating a radiation representative of a virtual shoot

at least one radiation sensor for detecting radiation emitted by other units,

a display with an aiming sight,

a direction-indicating sensor,

a satellite-based unit positioning means,

a memory for storing game data

the system further comprising communications channels between units for synchronizing game data between units, said communications channels comprising at least two among:
wireless TCP/IP communications via the Internet,
an IP-based ad-hoc network (MANET),
data modulation of the radiation generated by units and received by other units.
a sub-GHz network with sub-GHz nodes in each of the units.
Bluetooth communications.

Preferred but non limiting aspects of this system include the following features, taken individually or in any technically compatible combinations:
each unit comprises a combination of a dedicated unit and a standard smart communicating terminal, the dedicated unit including the directional radiation source an the radiation sensors and a sub-GHz network node.
said dedicated unit further comprises a circuit for modulating the generated radiation with game information.
said game information comprises at least a shooter unit identifier.
each unit comprises communications management means capable of causing synchronization of game data between two units, said management unit being responsive to the reception of a shooter unit identifier by said at least one radiation sensor at a target unit to synchronize game data between shooter unit and target unit.
said communications management means are adapted to cause exchange of redundant game data via at least two different communications channels.
said communications management means are adapted to prioritize game data information in case of adverse communications conditions.
priority game data include successful shot information and player unit displacements.

The present invention also provides smartphones, smartphone programs, dedicated devices, dedicated device programs, smartphone/device assemblies for use in these systems, as well as methods for implementing the system functionalities.

### BRIEF DESCRIPTION OF THE DRAWINGS

Other features, aims and advantages of the present invention will better appear from the following description of preferred embodiments thereof, given by way of non limiting example and with reference to the appended drawings, in which:

FIG. 1 is a block-diagram of a gaming system according to the present invention,

FIG. 2 is a perspective view of a handheld unit belonging to the system of FIG. 1,

FIG. 3 illustrates a process for handling a “Laser” shot in a handheld unit,

FIG. 4 illustrates a method for synchronizing game data between devices of the system,

FIG. 5 illustrates a first device position disambiguation process that can be implemented in a system according to the present invention,

FIG. 6 shows the steps of a method for ensuring such disambiguation,

FIG. 7 illustrates the steps of an alternative method for ensuring device position disambiguation,

FIG. 8 illustrates a gamer screen location process that can be implemented in a system according to the present invention, and

FIG. 9 illustrates an drone-based embodiment of a user device in a system according to the present invention.

### DETAILED DESCRIPTION OF PREFERRED EMBODIMENTS

As a preliminary note, it will be observed that certain of the reference signs below have no counterparts in the drawings but are used for clarity. Those reference signs which have no counterpart on the drawings are put between brackets.

It will be further observed that expressions such as ‘unit’, ‘module’, etc. are not supposed to refer to a specific hardware or physical architecture, but rather to functionalities of the equipment involved.

An improved Laser game system according to the present invention will now be described.

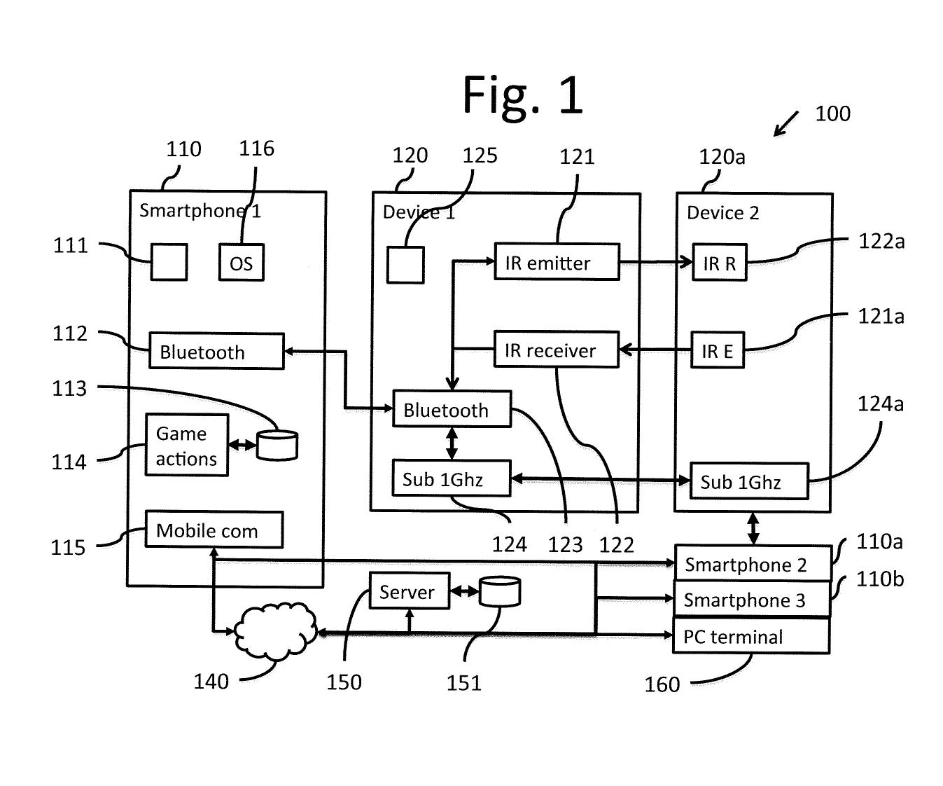

Referring to FIG. 1, a game system 100 comprises a plurality of handheld units consisting in smartphones 110, 110a, 110b, . . . respectively mounted on a plurality of dedicated game devices or “virtual guns” 120, 120a, 120b, . . . . Smartphones 110, 110a, 110b, . . . communicate with each other via a communications network 140 to which are also connected a game server 150 and terminals 160.

### Smartphone 110

In this embodiment, smartphone 110 is for instance of the iPhone® or Android® or Windows® type. It comprises in particular a sensor and actuator module 111, a Bluetooth® communications module 112, a game data storage module 113, a processor and game program module 114, a mobile internet connection management module 115 et an operating system 116.

Sensor and actuator module 111 comprises in particular a 3-axis gyroscope (1111), a 3-axis magnetometer (1112), a GPS (Global Positioning System) unit (1113), a camera 1114 and a touch screen (1115).

The Bluetooth® communications module 112 establishes a permanent, two-way and symmetrical communications channel with a Bluetooth® module 123 of a device 120. This channel creates a permanent logical connection between smartphone 110 and device 120.

The game data module 113 contains all game-related data. At the start of a game, the module content is synchronized with database 151 in server 151 via the mobile internet connection 115 and network 140. This allows:
copying game template data (1512) into the game template space (1132) of storage module 113: this typically includes information defining the game category (war game, Sci-Fi game, toons game, etc.), identifying the teams and their members, the type and quantity of ammunition, available weapons and armors, game rules, virtual interactions with real objects, virtual textures of the real environment, etc.;
copying the game parameters (1513) into the game parameters space (1133) of storage module 113: these typically include the players by team and player attributes data (nicknames, powers, scores, avatars, injuries, moods);
copying virtual object data (1514) into virtual object data space (1134) of storage module 113: these typically include flags, clue data, weapon data, ammunition data, medical or food resource data and their geographical positions in the real game environment, environment map, virtual territory data, etc.

The game data module 113 is enriched during the game with actions, parameter changes and other changes brought by the smartphone owner by means of sub-modules (1142-1143-1144) described in the following. These actions and changes are recorded and time-stamped in a timeline memory (1131).

The game data module 113 is synchronized during the game with game data modules 113a-113b contained in the smartphones 110a-110b of the other players in the game. This synchronization is performed by the method 400 as described herebelow.

The game program module 144 is a Laser game application with augmented reality, by which the geographical environment of a player is captured by camera 1114 and displayed on touch screen (1115). This module contains sub-modules (1141-1142-1143-1144) by which:
augmented reality functionalities (1141) allows superimposing to this display virtual images such as special effects: an aiming sight at the center of screen (1115), explosion, smoke, projectile trajectories, as well as weapons, armours, etc.
action functionalities (1142) allow a player to shoot, reload, select a weapon, select an armour, buy resources, see a map of the environment, etc.
parameterization functionalities (1143) allow a player to enroll in a tournament or in a game, to select a team, etc.
profiling functionalities (1144) allow a player to define his/her avatar, including attributes, an appearance, weapons and armour, powers, personality, etc.

The mobile internet connection management module 115 uses one or several standards such as Wi-Fi, 3G LTE or 4G. If necessary, it relies upon Wi-Fi servers or relays, not shown. This module has a communications node identifier 1151.

The operating system 116 implements an operating system program executed in a hardware architecture that includes in particular a microprocessor, memories and I/O ports. It controls and allows interaction between other modules and can load additional programs (1161-1162-1163-1164).

### Gun 120

The device 120 is a game ‘virtual gun’ provided with a so-called “Laser”, actually an infrared source 121, an multiple infrared receivers 122 capable of sensing the radiation from an infrared source 121a of another device 120a, a Bluetooth® communications module 123 capable of exchanging information with the Bluetooth® communications module of a smartphone 110 affixed to device 120. Device 120 further comprises a sub-Ghz communications module 124, switches and control buttons (not shown), among which a shooting trigger. This trigger causes the emission of a “Laser” flash by infrared source 121. Device 120 further comprises a control module 125 provided with a microcontroller (1251) which controls the various modules and their interactions. Control module 125 further comprises a modulator (1252) and a demodulator (1253) allowing to use a Laser flash to convey a certain amount of digital information via source 121 and to decode this information at receiver 122. This modulation can be performed by different approaches, among which:
frequency modulation of the infrared signal,
using several infrared LEDs with different wavelengths,
generating Laser bursts, with variable durations and intensities,
any combination of the above approaches.

Module 125 further contains an identifier (1254) of the gamer who owns device 120, stored in a memory (not shown). Finally, the Sub-GHz communications module 124 can be identified as a Sub-GHz communications node (1241).

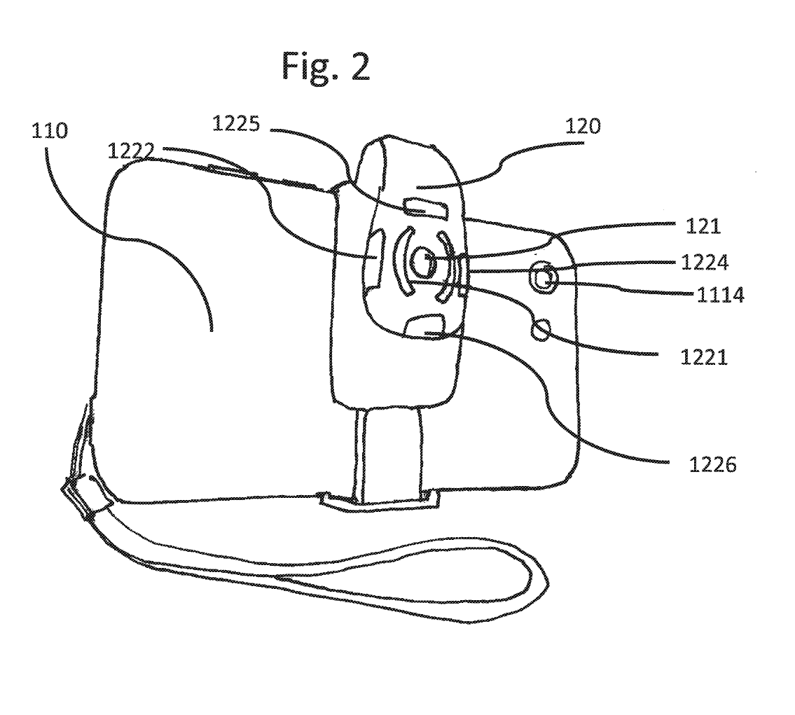

A second embodiment comprises, in addition to those of the first embodiment, the following features:
as shown in FIG. 2, the infrared sensor 122 comprises at least four infrared cells arranged crosswise with a front cell, 1221, a right side cell 1222, a rear cell (1223) and a left side cell 1224, and optional top cell 1225 and bottom cell 1226.

The operating system 116 comprises a geolocation program (1161) allowing a user provided with a smartphone to know his/her geolocation based on building pictures, without relying on a GPS. This location program 1161 is for instance the software commercially known as WhereAmI® developed by the Houston University, or Qualcomm's “Vuforia AR Extension for Unity®” implemented in applications developed by the University of Westminster.

Operating system 116 includes a map program such as Google Maps®, which geographically positions buildings and cooperates with geolocation program (1161).

A third embodiment comprises, in addition to those of the first embodiment, the following features:
a depth sensor (126) provided in device 120; various embodiments of such depth sensor can be implemented, among which:
   a light detection and ranging system (known under acronym LIDAR);
   a system based on stereoscopic analysis of clouds of points such as the Intel® long range depth camera;
   an assembly comprising an array of sonar sensors at the bottom, a Laser-range-finder (e.g. Laser scanner S300 manufactured by Sick AG, Waldkirch, Germany) and a Frontal CCD color camera, all controlled by a program 1164 as described hereinbelow.

Operating system 116 comprises a distance measurement program (1163) based on the depth sensor (126) and delivering distance data transmitted via the Bluetooth® connection 112-123. Operating system further comprises a 3D reconstruction program (1164) for generating 3D building representations. This may be based on one among:
a system described by Erik Einhorn, Christof Schröter and Horst-Michael from Gross Neuroinformatics and Cognitive Robotics Lab Ilmenau University of Technology, Germany in paper “Monocular Scene Reconstruction for Reliable Obstacle Detection and Robot Navigation”;
a mix of 3D data extracted from “Open Street Map®” and stereoscopic points clouds from the stereoscopic depth cameras

### Server 150

Server 150 comprises a computing architecture including an operating system and dedicated software (not illustrated) allowing a game organizer to prepare and manage Laser game session. This includes forming the teams, organizing tournaments, defining weapons and ammunition available at the start of the game, game duration, authorization or not to play inside buildings, etc.

Server 150 stores a game database 151 containing in particular a game timeline (1511), game template data (1512), game parameters (1513) and virtual object data (1514) for each game session.

A PC type terminal 160 is the remote computer system of a player, i.e. this terminal is not active on the game ground.

Smartphones 110, 110a et 110b, server 150 and terminals 160 communicate with each other via a network 140 such as the Internet, possibly through servers or relays (not shown).

It should be noted that smartphones 110, 110a et 110b are capable of communicating with each other in four different manners:
via Bluetooth® modules 112 and 123 on the one hand, and Sub-1 Ghz gateways 124 et 124a on the other hand;
via Bluetooth® modules 112 and 123 on the one hand, and infrared source/sensor 121-122a on the other hand;
directly via mobile internet connection modules 115, using for instance a mobile ad hoc network (MANET) such as a IETF;
via the mobile internet connection modules 115 and network 140.

### Shooting Process

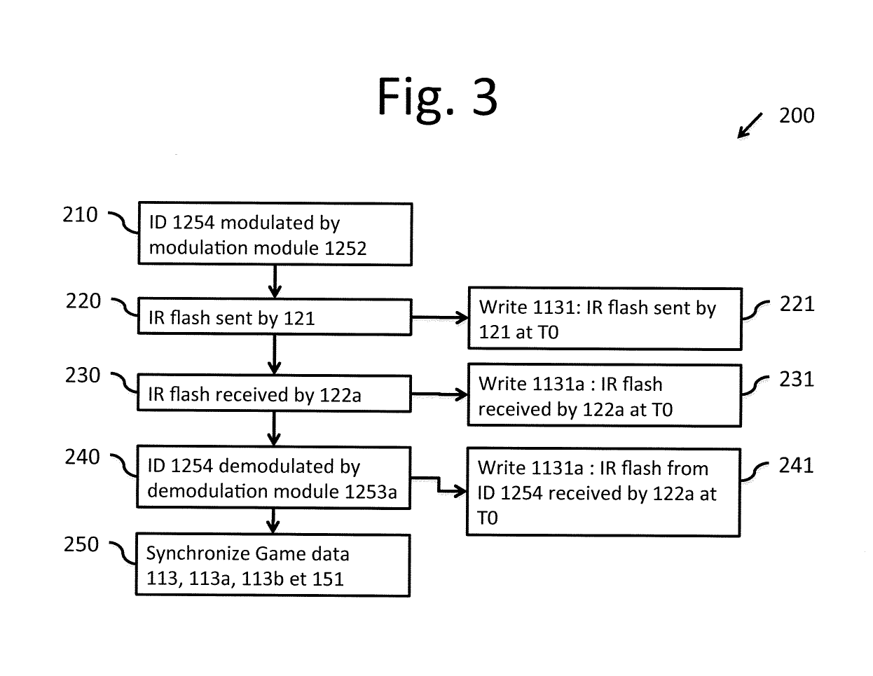

FIG. 3 illustrates a process 200 for handling a Laser shot by device 120 when player pulls the trigger, and for handling the reception of the shot at device 120a of the target player. This process is implemented by processor 114.

At step 210, modulation module (1252) receives the shooter identifier (1254) from smartphone 110 via the Bluetooth® connection 112-123; At step 220, infrared source 121 generates a modulated infrared flash containing identifier (1254) and transmits the shot information to smartphone 110 via Bluetooth® connection 112-123.

At step 221, game data module 113 at the shooter side records and time-stamps in timeline (1131) the event “Flash generated by source 121 at time T0 with identifier (1254)”.

At step 230, this flash is sensed by infrared cell 122a of the target player, and the target player device 120a transmits the shot reception information to smartphone 110a via the Bluetooth® connection 112a-123a.

At step 231, the game data module 113a at the target player side records and time-stamps in timeline 1131a the event “Flash received by cell 122a at time T0”.

At step 240, demodulator (1253a) demodulates the received flash in order to retrieve identifier 1254 and identify shooter, and this information is transmitted to smartphone 110a via the Bluetooth® connection 112a, 123a. At step 241, game data module 113a of target player records and time-stamps in timeline (1131a) the event “Flash received by sensor 122a at time T0, sent by shooter having ID defined in ‘1254)”.

At step 250, the game data modules 113, 113a, 113b and 151 are synchronized as detailed in the description of method 400 hereinbelow.

In a variant embodiment, the trigger is replaced by a virtual button on touch screen 1115. Therefore, process 200 includes preliminary steps, not shown, as follows:
player pushes trigger button on touch screen (1115);
processor and game module 114 generates an ID;
smartphone 110 transmits ID to device 120 through Bluetooth® connection 112-123;
at step 210, modulation module (1252) generates the signal encoding the shooter identifier 1254 based on the received ID.

### GPS Disambiguation Process 1

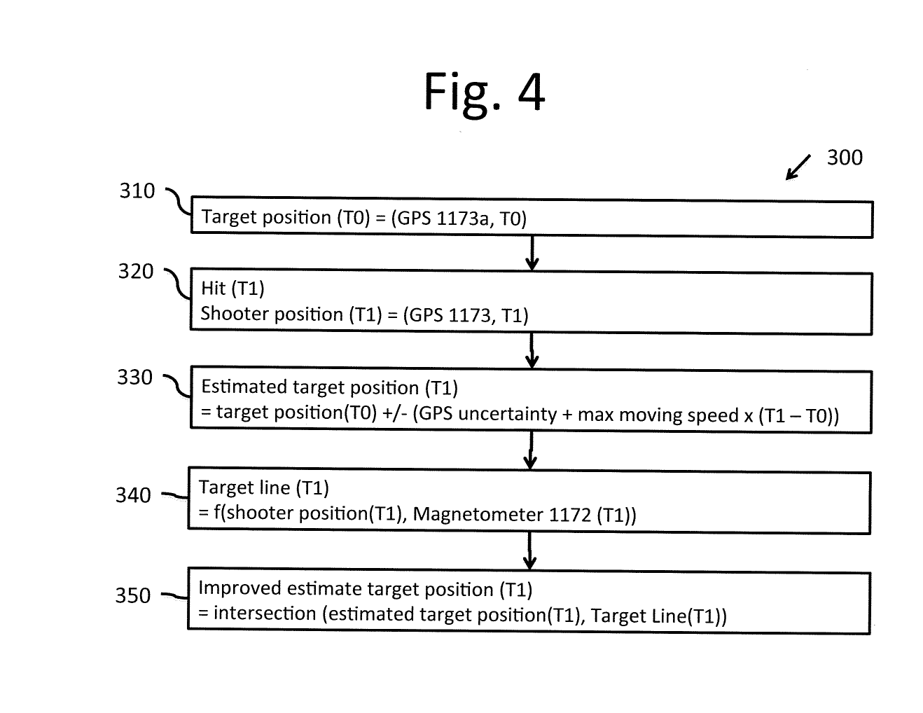

GPS unit 1113a usually has an accuracy of 5 to 20 meters, and is not available or reliable when the sky is not clear enough. An approach according to one aspect of the system allows improving the determination of a player position and is implemented in method 300 illustrated in FIG. 4, embodied by instructions of program 114.

At step 310, the geographical position of target player at time T0 is provided by GPS unit 1113a.

At step 320, the shoot by gun 120 reaches is target 120a at time T1. The geographical position of shooter at time T1 is provided by shooter's GPS unit 1113.

At step 330, implemented if the GPS unit 1113a of target player is not capable of delivering position data, the geographical position of target player at time T1 is estimated according to the following formula:

Estimated target position(T1)=target position(T0)+/−(GPS uncertainty+max moving speed×(T1−T0))

where
GPS uncertainty is the uncertainty associated with the inherent inaccuracy of the GPS system, and
max moving speed is the maximum displacement velocity of a player, e.g. 10 mph.

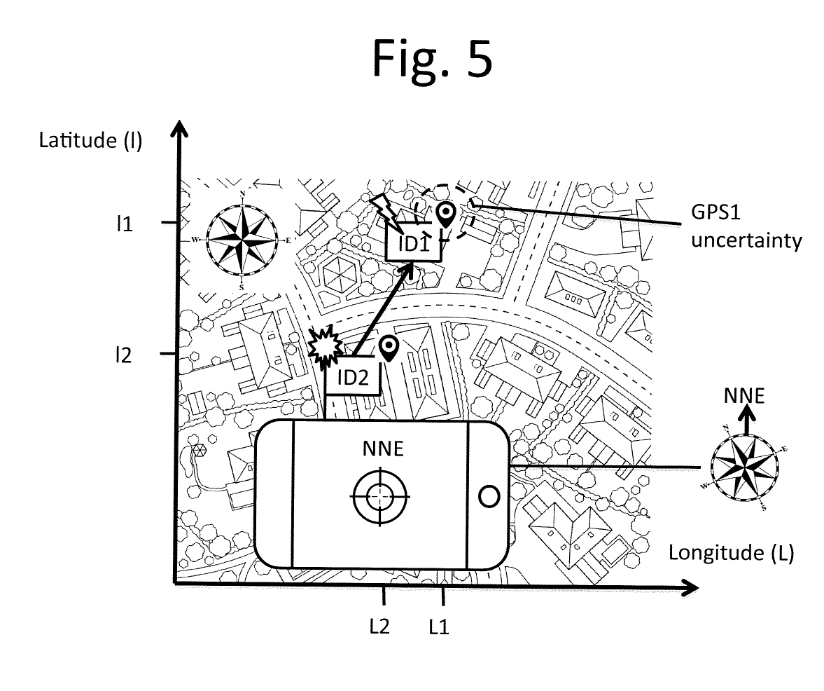

The estimated position at time T1 can therefore be illustrated by a disc centered on the player position at time T0 (as shown in FIG. 5) and the diameter of which is proportional to the GPS uncertainty, to the maximum displacement velocity and to the time difference between T0 and T1. At step 340, a target line at time T1 is defined as the geographical line extending through the player position at time T1, provided by GPS unit (1113) at time T1, and having the direction provided by magnetometer (1112) at time T1. Indeed, at time T1 the target player is in the sight (11151) of the shooter's smartphone. As this sight is centered on the display or smartphone 120, the geomagnetic orientation measured by magnetometer (1112) provides the direction of target player at time T1.

At step 350, the improved estimate target position at time T1 is defined as the intersection between the estimate target position at time T1 and the target Line at time T1.

This method thus allows substantially improving the determination of the geographical location of a target player despite its own GPS unit being temporarily unavailable, by using the position of the shooter's device 120 and shooter's magnetometer (1112).

In a first variant embodiment, an uncertainty can be allocated to the shooter position provided by its own GPS (1113), which is equivalent to converting its “target line” into a target band having a width proportional to the uncertainty. From there, the “improved estimate target position at time T1” at step 350 is defined as the intersection between the “estimate target position at time T1” and a rectangle having a long axis along “Target Line at time T1” and a short dimension given by the position uncertainty of shooter perpendicularly to said long axis. Similarly, if the GPS unit (1113) at the shooter side is not available at time T1, then the shooter's geographical position can be estimated based on a geographical position thereof at an earlier time, to which an additional uncertainty is added, as determined by his/her maximum displacement velocity in a similar way as method 330 for target player.

In a second variant embodiment, based on the second embodiment, the location program (1161) accurately knows the geolocation of certain buildings in particular. This program (1161) is adapted to recognize a building by comparing landmarks or reference points of its representation on screen (1115) with landmarks or reference points of an integrated image base. Thus an image displayed on screen at time T1 and containing a building which can be identified accordingly, allows precisely identifying the location of a point of the building aimed at by sight (11151) of shooter device. This method allows decreasing the width of the above-mentioned rectangle, and therefore improving the geolocation estimates for the two players.

In a third variant embodiment based on the second embodiment, the geographical map program (1162) is adapted to locate the positions of buildings in general. If the game parameters defined at server 150 do not allow playing inside buildings in certain predefined areas, then the game area is voided from the areas covered by such buildings. The “improved estimate target position at time T1” defined at step 350 can is made more accurate by intersection with the voided game area.

In a fourth variant embodiment based on third embodiment, the program (1164) for 3D reconstruction of the environment reconstructs a map of the buildings. This is a variant embodiment to the third variant hereinabove for voiding the game area with the positions of the reconstructed buildings.

In a fifth variant embodiment based on the first embodiment, the position of target at time T1 can be used again to compute a new position thereof at time T2. This allows, in case of cross-shooting between several players, to substantially decrease the location inaccuracies by using the intersections between several “target lines”. In such case, the initial target position at time T0 at step 310 is replaced with target position at time T1.

In a sixth variant embodiment based on the third embodiment, the distance determination program (1163) allows defining the target player position with greater accuracy. Program (1163) indeed provides the distance between shooter and target player who appears in sight (11151) at time T1. From there, the improved estimate target position at time T1 is defined with greater accuracy at step 350 by using intersection with this distance.

These different variants can be combined with each other in accordance to the embodiment preferred and the processing capabilities of the smartphones.

Finally, the method 300 can be used to render the shooter's location (rather than the target player's position) more precise in case the location uncertainty concerns the shooter and not the target player. In this case, at step 350 the improved estimate shooter position at time T1 is defined by the intersection between the estimated shooter position at time T1 and the shooter line at time T1, which extends through the GPS location of target at time T1 and the direction of which is provided by the shooter magnetometer.

### Server-Free Network

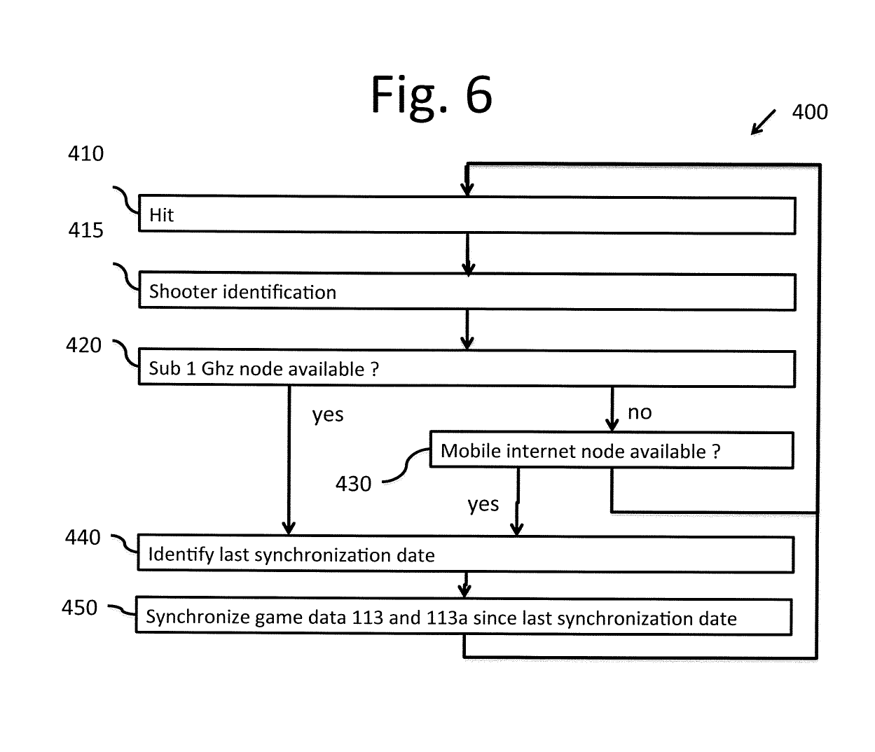

FIG. 6 illustrates a server-free method 400 for synchronizing the game data, implemented in module 114.

At step 410, the target player equipped with device 120a has been hit by a shoot from another device 120-120b. This step can be triggered by step 231 of method 200.

At step 415, the shooter is identified by the target player by means of its identifier (1254) and of step 241 of method 200.

At step 420, the Sub-1 GHz communications module 124a activates communications node (1241) corresponding to identifier (1254). This step can be triggered by step 250 of method 200.

At step 430, the mobile internet connection module 115a checks the availability of communication node (1151), the latter being addressed directly or via network 140.

At step 440, a communications channel is set between smartphones 110 and 110a. An initial information exchange allows determining the most recent synchronization date between the respective game data modules 113 and 113a.

At step 450, the game data modules 113 and 113a synchronize their data that need to be synchronized since the last one.

In variant embodiments:
in the case where the shooter ID cannot be determined at step 415 because of data corruption or infrared transmission corruption, or in case communications via the sub-GHz nodes for synchronization purposes cannot be achieved, then the mobile communications channel via network 140 can be used as a backup (although with slower transmission) for ensuring at least priority data transmission such as successful shot events, player movements, etc. More precisely, a degraded mode handling provides that:
   at step 420 the Sub-1 GHz communications management module 124a looks up for all available Sub-1 GHz nodes 1241-1241b;
   if this look-up fails, then at step 430, the mobile internet connection management module 115a looks up for all available nodes 1151-1151b;
   at step 440, the communication is established between smartphone 110a and server 150 via the Sub-GHz route or the mobile communications route; a synchronization between data modules 113a and 151 is then performed;
   if several available communications nodes are identified at step 420 or 430, the node selection for synchronization preferably is the one for which the most recent synchronization is the most remote in the past;
several re-executions of the method 400 are possible, with an adjustable timing, by redirecting the execution back to step 420.
   this frequency can be increased in order to decrease communications latency; it can be decreased so as to increase battery lifetime.
   this frequency can vary according to the game data 113, in particular if two players are close to each other or if one of the players aims at the other without shooting;
   this redirection can alternatively be made back to step 430 in order to promote the exchange of information via the wireless network 140, e.g. if the player is located close to a network wireless equipment;
   step 430 can be authorized only at certain phases of the game, e.g. at the beginning and end of a game;
   steps 420 and 430 can be bypassed for broadcasting directly the synchronization information to all available nodes both through sub-Ghz and mobile network channels;
the steps can be executed in a different order; a shoot by a player can cause at the same time two transmissions, one infrared and the other in the sub-GHz band. Communications redundancy can indeed be desirable in order to increase the effectiveness of information exchange.
the date of the most recent synchronization can be adjusted so as to take into account indirect synchronization. Indeed, if T0<T1<T2<T3 and if
   T0 is the time of A/B synchronization,
   T1 is the time of B/C synchronization,
   T2 is the time of A/C synchronization,
      then at time T3, the most recent indirect synchronization between A and B is T1>T0.
other optimizations of the synchronization between all the game data modules 113-113a-113b-151 can be implemented so as to take into account partial synchronizations due to communications disruptions, or priority ranking of information to be communicated (e. g. “player X was shot by player Y” or “player X moved to position (x,y,z)”.

This method allows synchronizing, during the whole game, all the game data modules 113-113a-113b-151 despite a low signal-to-noise ratio and possibly frequent communications disruptions. Indeed, this synchronization is made only when a player shoot has hit a target, and only between the devices of these two players in order to maximize the probability of a reliable communication between their smartphones, and to minimize power consumption.

### GPS Disambiguation Process No. 2

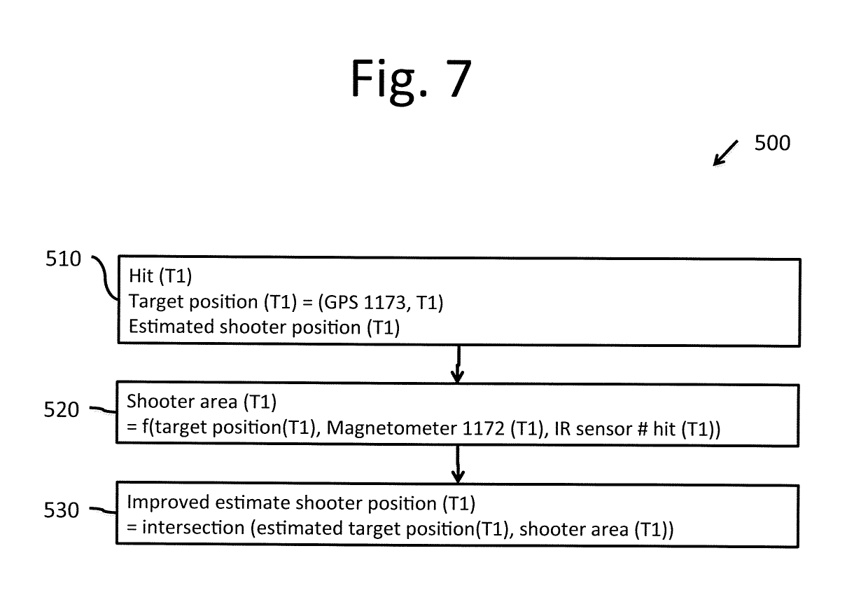

FIG. 7 illustrates a method 500 implemented by the game program module 114, intended to improve the geolocation of a player in the second embodiment.

At step 510, the shooter equipped with gun 120a hits the target player equipped with gun 120. The position of target player at time T1 is provided by his GPS unit (1113). The position of the shooter is estimated according to the method explained at step 330 of method 300.

At step 520, the shooter zone at time T1 is computed in the following manner:
if the hit sensor is the forward one (1221), then the shooter direction is the one provided at time T1 by magnetometer (1112) of target player, with a margin of +/−45°;
if the hit sensor is the right-side one 1222, then the shooter direction is the one provided at time T1 by magnetometer (1112) of target player, with a shifted margin of +45°/+135°;
if the hit sensor is the rear-side one 1223, then the shooter direction is the one provided at time T1 by magnetometer (1112) of target player, with a shifted margin of +135°/−135°;
if the hit sensor is the left-side one 1224, then the shooter direction is the one provided at time T1 by magnetometer (1112) of target player, with a shifted margin of −45°/−135°;
the shooter zone at time T1 is a disc sector:
   whose apex is the position of target player at time T1,
   whose radius is the maximum sensing distance of a Laser ray 121a by a sensor 122, and
   whose direction is provided by the shooter direction as defined in the above paragraphs.

At step 530, the improved estimate shooter position at time T1 is computed as the intersection of the estimated shooter position at time T1 and the shooter zone at time T1.

As variant embodiments:
the number of sensors (1221-1222-1223-1224) can be increased and their sensing angular range can be decreased in order to decrease the shooter area width;
the use of different sensors having different maximum sensing distances allows, by mutual comparison of the signals received by said sensors, to decrease the uncertainty of the shooter distance and thus of the shooter area;
the use of sensors having aperture angles that partially overlap and having a sensitivity that varies with the angle, allows reducing the shooter area width by virtue of the difference in flash intensity sensed by two adjacent sensors;
up and down sensors can be added to take into consideration the angular position of apparatus 120 at the time of impact of to achieve a 3D definition of the shooter position;
the same method can be used to make the target player position more accurate if it is uncertain, and if the shooter position is known.

### Gamer Screen Location Process

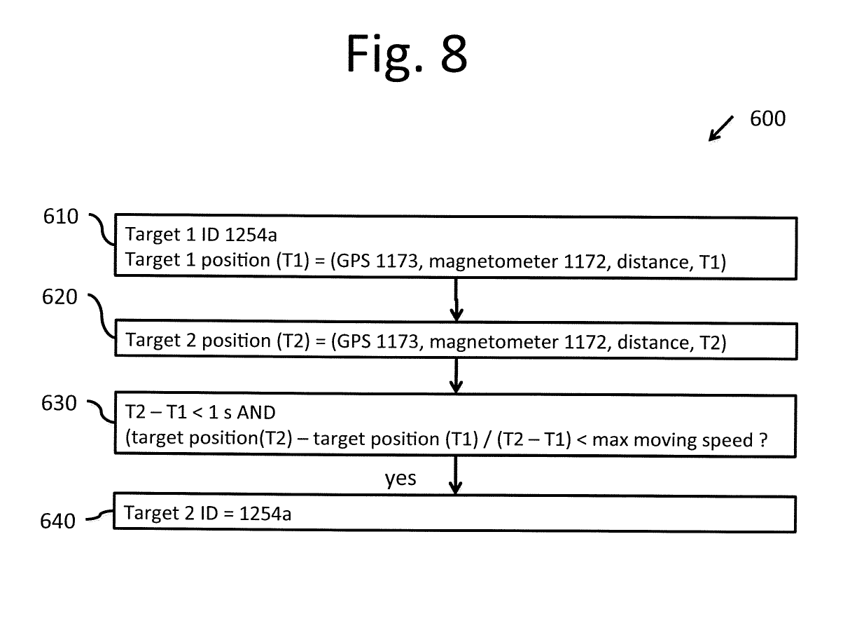

FIG. 8 illustrates a method 600 implemented by the game program module 114 for locating a target player whose GPS data are not available.

At step 610, a target player #1 is identified by his/her identifier (1254a) according to one of the above-described methods. The position of this target player #1 at time T1 is computed in the following manner:
the end of a segment between shooter and this target player #1 is the position provided by the GPS unit of shooter at time T1;
the direction of this segment is provided by magnetometer (1112) of shooter at time T1;
the length of this segment is provided by the distance measurement program (1163) at time T1;
the other end of the segment provides the position of target player #1 at time T1.

At step 620, the position of a target player #2 at time T2 is computed according to the same method.

At step 630, the following two-prong test is performed:
is the time difference between T1 and T2 shorter than a predetermined duration (e.g. 1 second)?
is the distance between the positions of target players #1 and #2 at times T1 and T2, divided by the time difference between T1 and T2, lower than a maximum displacement speed of a player (e.g. 10 mph)?

At step 640, which is executed if the test at step 630 is successful, the target player #2 is identified as target player #1 with identifier (1254a).

This method thus allows identifying and locating a target player, as long as he/she is followed on the display of another player, even though the GPS signal for this target has been lost.

In a variant embodiment, if the target player does not appear at times T1 and T2 at the center of the matrix of depth sensor 126 but in an offset region, a correction can be brought to the direction given by magnetometer (1112). If for instance the aperture of depth sensor (126) is an angle of +/−20° and if target player 1 appears at the right end of sensor (126) at time T1, then 20° can be added to the direction provided by magnetometer (1112) at step 610. The same will be done at step 620.

### Extensions

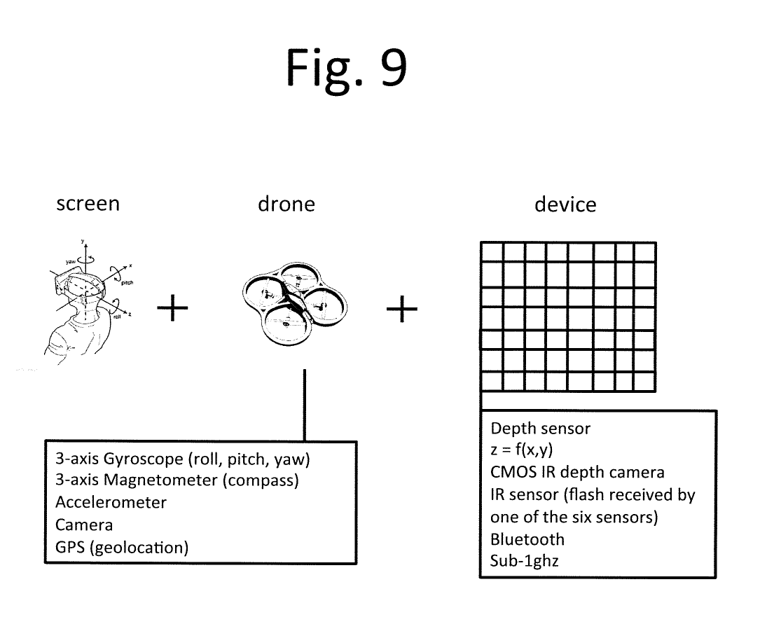

Other embodiments of this invention are possible. In particular:
all or parts of the controls of device 120, including the trigger, can be replaced (or duplicated) with virtual buttons displayed on touch screen (1115), and vice-versa; the device/smartphone Bluetooth® connection indeed allows, by virtue of a fast information transmission therebetween, to indifferently use controls on smartphone 110 or on device 120;
augmented reality functionalities (1141) can retexture the environment, e.g. real 3D buildings can be replaced by virtual 3D buildings and virtual avatars can be substituted to real players;
as illustrated in FIG. 9, device 120 can be a drone such as one manufactured by French company Parrot®, driven from a smartphone 110; in such case, the Bluetooth connection 112-123 is preferable replaced by an extended-range connection such as Wi-Fi Mimo®; such a drone should comprise a magnetometer and a camera, respectively playing the roles, via the Wi-Fi Mimo® connection, of magnetometer (1112) and camera 1114.
smartphone 100 can be equipped with a gesture recognition device, e.g Microsoft Kinect®; device 120 equipped with depth sensor 126 sends a 3D image through bluetooth; smartphone 100 will recognize gestures of the players and act like an augmented reality enhancer
smartphone 110 can be replaced with a tablet, a PC (preferably a laptop), or a PC provided with virtual reality goggles such as the ones known under the commercial name Oculus®
all or part of the smartphone functionalities can be implemented in a “smartwatch”.

1. A virtual shooting game system, comprising a plurality of player units, each player unit comprising:
a directional radiation source capable of selectively generating a radiation representative of a virtual shot,
at least one radiation sensor for detecting radiation emitted by other units,
a camera,
a display with an aiming sight,
a direction-indicating sensor,
a satellite-based unit positioning means,
communications channels between units,
location means for determining the position of each unit, using position information delivered by said positioning means and, whenever said position information is not available or reliable at a given unit, shot direction information provided by the direction indicating sensor of at least one unit.

2. A virtual shooting game system according to claim 1, wherein said shot direction information is determined at the time a virtual shot is generated at said given unit and received at another unit, or vice versa.

3. A system according to claim 1, wherein said location means further use position uncertainty information based on the maximum displacement velocity of a player holding a unit combined with time difference information between a previous time at which a position had been determined or estimated and a current time.

4. A system according to claim 1, wherein each unit further comprises distance determination means, and said location means further use inter-unit distance information provided by said distance determination means.

5. A system according to claim 1, wherein each unit comprises a plurality of radiation sensors receptive to radiation reaching the unit from different directions, respectively, and said location means further use geometric information corresponding to reception patterns of said plurality of radiation sensors.

6. A system according to claim 1, wherein said location means comprises reference point identification means for identifying in the images captured by the camera reference points having visual identity and known position.

7. A system according to claim 1, wherein said location means further use an uncertainty factor of the position information delivered by said positioning means.

8. A system according to claim 1, wherein the location means use a plurality of shot directions provided by the direction indicating sensors of at least two units generating shots in a cross-shooting situation.

9. A system according to claim 1, wherein each unit comprises a combination of a dedicated device and a standard smart communicating terminal, the dedicated including the directional radiation source an the radiation sensors.

10. A system according to claim 9, wherein each unit further comprises a wireless communications channel between the smart terminal and the dedicated unit.

11. A virtual shooting game system, comprising a plurality of player units, each player unit comprising:
a directional radiation source capable of selectively generating a radiation representative of a virtual shoot
at least one radiation sensor for detecting radiation emitted by other units,
a display with an aiming sight,
a direction-indicating sensor,
a satellite-based unit positioning means,
a memory for storing game data
the system further comprising communications channels between units for synchronizing game data between units, said communications channels comprising at least two among:
wireless TCP/IP communications via the Internet,
an IP-based ad-hoc network (MANET),
data modulation of the radiation generated by units and received by other units.
a sub-GHz network with sub-GHz nodes in each of the units.
Bluetooth communications.

12. A system according to claim 11, wherein each unit comprises a combination of a dedicated unit and a standard smart communicating terminal, the dedicated unit including the directional radiation source an the radiation sensors and a sub-GHz network node.

13. A system according to claim 12, wherein said dedicated unit further comprises a circuit for modulating the generated radiation with game information.

14. A system according to claim 13, wherein said game information comprises at least a shooter unit identifier.

15. A system according to claim 11, wherein each unit comprises communications management means capable of causing synchronization of game data between two units, said management unit being responsive to the reception of a shooter unit identifier by said at least one radiation sensor at a target unit to synchronize game data between shooter unit and target unit.

16. A system according to claim 15, wherein said communications management means are adapted to cause exchange of redundant game data via at least two different communications channels.

17. A system according to claim 15, wherein said communications management means are adapted to prioritize game data information in case of adverse communications conditions.

18. A system according to claim 17, wherein priority game data include successful shot information and player unit displacements.

19. A system according to claim 16, wherein said communications management means are adapted to prioritize game data information in case of adverse communications conditions.
